(19) United States
(12) Patent Application Publication
(10) Pub. No.: US 2024/0016166 A1
(43) Pub. Date: Jan. 18, 2024

(54) FOOD DOUGH FORMING APPARATUS

(71) Applicant: Won Oh CHO, Cheonan-si (KR)

(72) Inventor: Won Oh CHO, Cheonan-si (KR)

(21) Appl. No.: 18/352,433

(22) Filed: Jul. 14, 2023

(30) Foreign Application Priority Data
Jul. 15, 2022 (KR) 10-2022-0087565

(51) Int. Cl. A22C 7/00

(52) U.S. Cl. CPC A22C 7/0076

(57) ABSTRACT

Disclosed is a food dough forming apparatus including a base, a receiving container installed above the base and configured to receive food dough, the receiving container having a discharge hole at a lower part thereof, a pressing part configured to press the food dough received in the receiving container downward, a forming part installed movably under the receiving container, the forming part having a forming frame configured to form the food dough discharged through the discharge hole by being pressed by the pressing part inside the receiving container into a preset shape, and a separating part configured to separate the formed dough formed in the forming part from the forming part.

### CROSS REFERENCE TO RELATED APPLICATION

The present application claims priority to Korean Patent Application No. 10-2022-0087565, filed Jul. 15, 2022, which is incorporated herein by reference in its entirety.

### BACKGROUND

### 1. Technical Field

The present disclosure relates generally to a food dough forming apparatus. More particularly, the present disclosure relates to a food dough forming apparatus for automatically forming food dough into constant mass, size, and shape.

### 2. Description of the Related Art

Due to the recent westernization of dietary culture and the influence of busy lifestyles, people of all ages and genders are using various types of bread as a substitute for meals. When a hamburger among them is eaten, bread and meat can be together eaten to increase satiety, so a hamburger is preferred by many consumers.

It is common to make a hamburger by using a patty made of vegetables, sauce, beef, pork, and chicken, etc. in the right amount between two pieces of bread. Particularly, since a hamburger patty is manufactured through processes such as salting and aging by mixing various raw materials, it is an important factor that can determine the type of a hamburger. Accordingly, depending on which raw materials are used during the manufacturing of a patty, the quality and taste of the patty are greatly affected.

On the other hand, a conventional hamburger patty mainly uses meat as a main raw material for taste and nutrition, and is manufactured by processing the meat in a minced form, that is, in the form of dough and then forming the minced meat into a desired size.

However, conventionally, since hamburger patties were made by a person manually patting or pressing food dough, time to make patties was different depending on skill level, and the mass, size, and shape of patties were not constant.

### SUMMARY

Accordingly, the present disclosure has been made keeping in mind the above problems occurring in the related art, and the present disclosure is intended to propose a food dough forming apparatus for automatically forming food dough into constant mass, size, and shape.

In order to achieve the above objective, according to one aspect of the present disclosure, there is provided a food dough forming apparatus including: a base; a receiving container installed above the base and configured to receive food dough, the receiving container having a discharge hole at a lower part thereof; a pressing part configured to press the food dough received in the receiving container downward; a forming part installed movably under the receiving container, the forming part having a forming frame configured to form the food dough discharged through the discharge hole by being pressed by the pressing part inside the receiving container into a preset shape; and a separating part configured to separate the formed dough formed in the forming part from the forming part.

Accordingly, formed dough, such as a patty for a hamburger, may be easily made into constant mass, size, and shape.

Here, the forming part may include: a blocking wall installed by being spaced apart from the discharge hole of the receiving container so that the blocking wall faces the discharge hole; and a forming frame member installed between the blocking wall and the discharge hole of the receiving container so that the forming frame member is capable of reciprocating, the forming frame member having a forming hole formed vertically therethrough so that the formed dough is formed in the forming hole.

Accordingly, formed dough of a desired shape may be easily made.

In addition, the forming hole may include one pair of forming holes formed by being spaced apart from each other.

Accordingly, the production time of the formed dough having a desired shape may be decreased.

Here, the separating part may include: a support plate fixedly installed on the blocking wall such that the support plate is spaced apart from the forming frame member by facing the forming frame member; and a pushing member installed on the support plate such that the pushing member is capable of moving up and down, the pushing member being configured to push the formed dough filled in the forming hole of the forming frame member out of the discharge hole of the receiving container during descent of the pushing member.

Accordingly, the formed dough may be safely separated from the forming frame member without damage.

In addition, the food dough forming apparatus may further include: a forming frame moving member configured to horizontally reciprocate the forming frame member by an external force.

Accordingly, a worker may easily move the forming frame member to perform work conveniently.

In addition, the pressing part may include: a pressing member which is in close contact with an inner surface of the receiving container and pushes the food dough toward the discharge hole while moving; a pressing rod connected to the pressing member and supported to be movable in an introduction hole of the receiving container; and a pressing-rod driving part configured to reciprocate the pressing rod.

Accordingly, the formed dough may be pressed and formed with a predetermined pressing force so that a formed shape of the formed dough can be stably maintained.

According to the food dough forming apparatus of the present disclosure, it is possible to repeatedly and easily produce formed dough in a desired shape by pressing food dough.

Particularly, formed dough is formed into a desired shape by applying constant pressure in the forming frame member, so the formed dough can maintain a shape thereof.

Accordingly, formed dough, such as a hamburger patty, which is required to have constant mass, size, and shape, can be easily formed so that work time and production time are reduced, thereby reducing costs.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1A is a perspective view illustrating a food dough forming apparatus according to an embodiment of the present disclosure;

FIG. 1B is a top plan view of the food dough forming apparatus illustrated in FIG. 1A;

FIG. 1C is a front view of the food dough forming apparatus illustrated in FIG. 1A;

FIG. 2A is a perspective view illustrating a state in which the position of a forming part is adjusted in a state of FIG. 1A;

FIG. 2b is a top plan view of the food dough forming apparatus illustrated in FIG. 2A;

FIG. 2C is a front view of the food dough forming apparatus illustrated in FIG. 2A;

FIGS. 3A and 3B are respectively vertical cross-sectional views of the food dough forming apparatus illustrated in FIG. 1A; and

FIG. 4 is a schematic cross-sectional view illustrating another example of a pressing-rod driving part.

### DETAILED DESCRIPTION

Hereinafter, a food dough forming apparatus according to an exemplary embodiment of the present disclosure will be described in detail in order to achieve the above objectives.

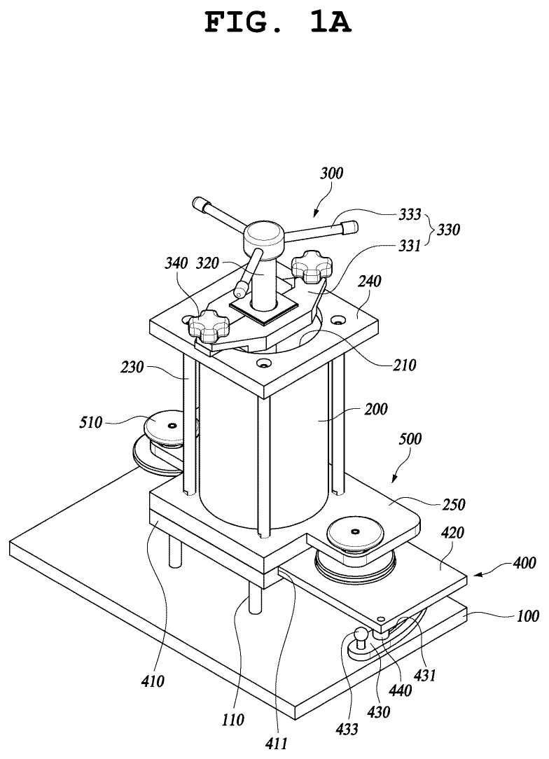

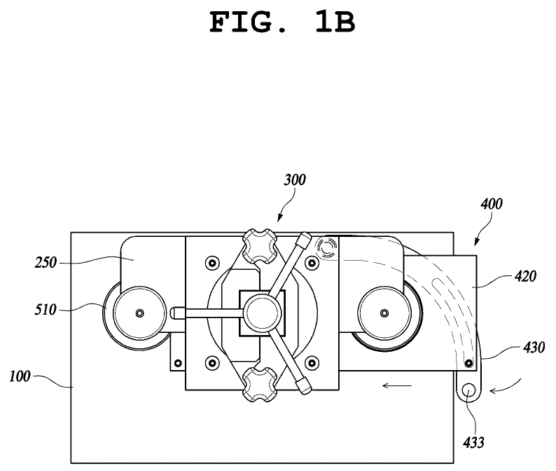

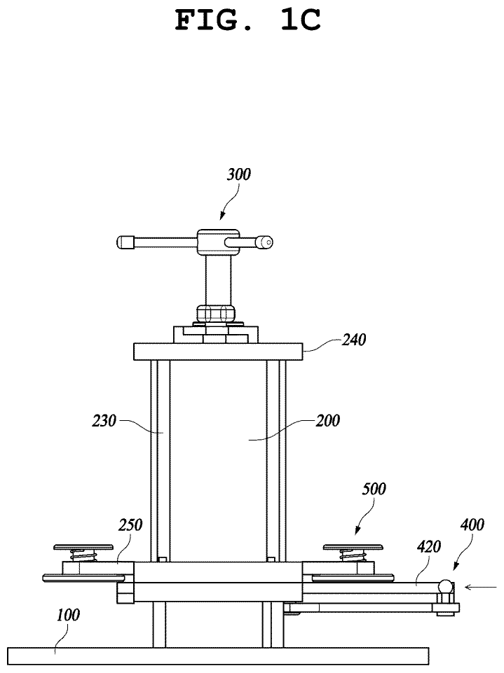

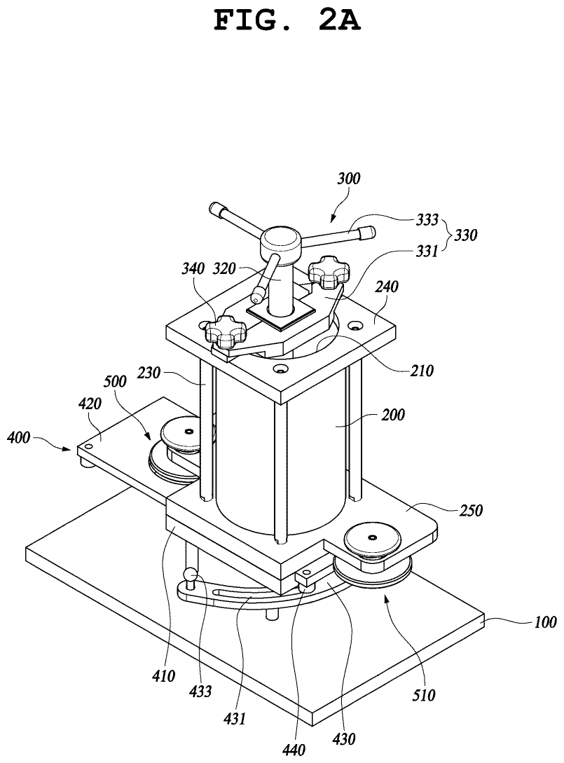

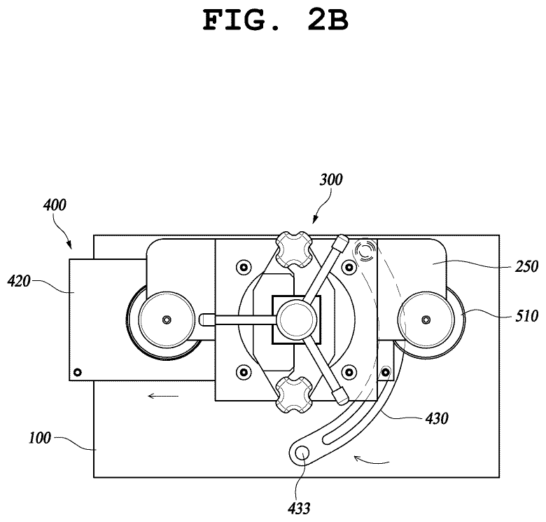

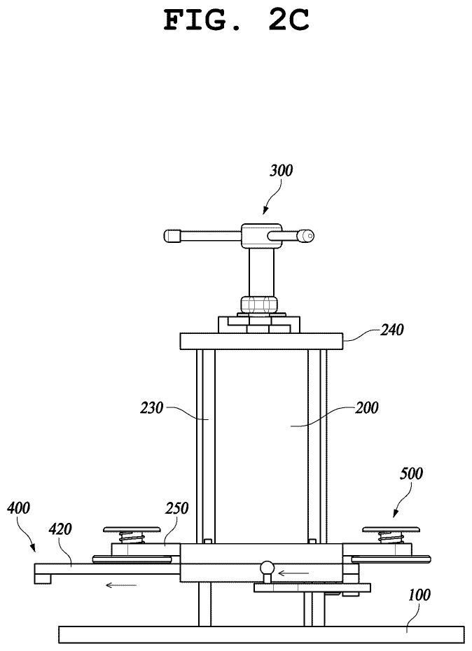

Referring to FIGS. 1A to 3B, the food dough forming apparatus according to the embodiment of the present disclosure includes a base 100, a receiving container 200 installed above the base 100 and configured to receive food dough 10, a pressing part 300 configured to press food dough received in the receiving container 200 downward, a forming part 400 installed under the receiving container 200, and a separating part 500 configured to separate formed dough 20 formed in the forming part 400 from the forming part 400.

The forming part 400 is installed above the base 100 by being spaced apart by a predetermined height from the base 100 by supports 110.

The receiving container 200 is fixedly installed on the upper part of the forming part 400. The receiving container 200, which has a tubular structure, has an open introduction hole 210 formed at an upper part thereof and a discharge hole 220 formed at a lower part thereof. The receiving container 200 preferably has a cylindrical structure. The receiving container 200 has an outer side supported by a plurality of support rods 230. A first end of each of the support rods 230 is connected to the forming part 400, and a second end of the support rod 230 is connected to a support flange 240 coupled to the upper end of the receiving container 200 so that the support flange 240 faces the forming part 400.

The forming part 400 includes a blocking wall 410 installed by being spaced apart from the discharge hole 220 so that the blocking wall 410 faces the discharge hole 220 of the receiving container 200, and a forming frame member 420 installed between the blocking wall 410 and the discharge hole 220 of the receiving container 200 so that the forming frame member 420 can reciprocate.

The blocking wall 410 is fixedly installed at a position above the base 100 and has a plate structure. The blocking wall 410 has a guide part 411 to which the forming frame member 420 is coupled to reciprocate.

The forming frame member 420 is coupled to the guide part 411 and is reciprocated by an external force. Preferably, a support plate 250 is fixedly coupled to the lower end of the receiving container 200, and the support plate 250 and the blocking wall 410 are coupled to each other by being in close contact with each other. Accordingly, the forming frame member 420 is installed to be capable of reciprocating between the support plate 250 and the blocking wall 410. The forming frame member 420 has a forming hole 421 formed vertically therethrough so that the formed dough 20 is formed in the forming hole 421. Preferably, the forming hole 421 is formed vertically through the forming frame member 420 and includes one pair of forming holes formed by being spaced apart from each other.

The food dough forming apparatus further includes a forming frame moving member 430 for horizontally reciprocating the forming frame member 420. The forming frame moving member 430 has a first end connected rotatably to the blocking wall 410 and is formed to be round in a streamlined shape between the first end and a second end thereof. The forming frame moving member 430 has a guide slit 431 formed in a longitudinal direction thereof. An interlocking protrusion 440 coupled to the guide slit 431 is installed by protruding from the forming frame member 420. According to such configuration, when the forming frame moving member 430 is rotated by holding a handle 433 installed on the second end of the forming frame moving member 430, the relative position of the interlocking protrusion 440 connected to the guide slit 431 is moved, and the forming frame member 420 is moved horizontally. Accordingly, the forming frame member 420 can be easily horizontally moved.

The pressing part 300 is intended to press the food dough 10 received in the receiving container 200 downward so as to fill the food dough 10 in the forming hole 421 of the forming frame member 420 so that the formed dough 20 is formed.

The separating part 500 includes the support plate 250 fixedly installed on the blocking wall 410 such that the support plate 250 is spaced apart from the forming frame member 420 by facing the forming frame member 420, and a pushing member 510 installed on the support plate 250 such that the pushing member 510 can move up and down.

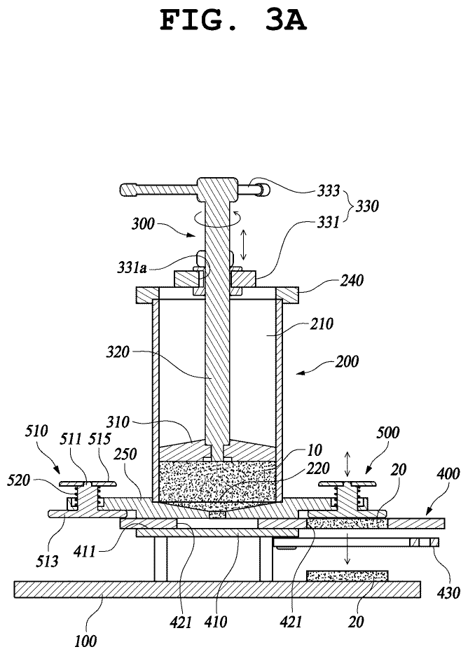

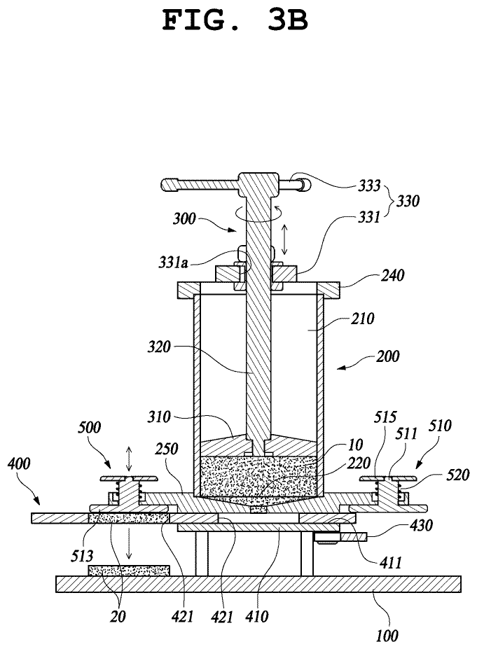

The pushing member 510 has a connecting part 511 coupled to the support plate 250 so that a connecting part 511 can reciprocate by passing vertically through the support plate 250, a push part 513 connected to the lower end of the connecting part 511 so that the push part 513 expands at the lower end, with the push part 513 being configured to push the formed dough 20 filled in the forming hole 421, and a press part 515 connected to the upper end of the connecting part 511. An elastic member 520 is installed in the connecting part 511 to provide a returning force to the push part 513 so that the push part 513 can move out of the inside of the forming hole 421 which the push part 513 enters. Accordingly, as illustrated in FIG. 3B, in a state in which the forming hole 421 of the forming frame member 420 is located under the push part 513, when a worker presses the press part 515, the push part 513 pushes the formed dough 20 filled in the forming hole 421 while descending so that the formed dough 20 is separated from the forming hole 421.

The pushing member 510 having the configuration includes one pair of pushing members installed symmetrically on opposite sides of the support plate 250.

The pressing part 300 includes a pressing member 310 which is in close contact with the inner surface of the receiving container 200 and pushes the food dough 10 toward the discharge hole 220 while moving, a pressing rod 320 connected to the pressing member 310 and supported to be movable in the introduction hole of the receiving container 200, and a pressing-rod driving part 330 configured to reciprocate the pressing rod 320.

The pressing member 310, which has a piston structure, serves to press the food dough 10 while moving in close contact with the inner surface of the receiving container 200 and to push and move the food dough 10 toward the discharge hole 220.

The pressing rod 320 is preferably a threaded rod having threads formed on an outer circumference thereof and is connected to the center of the pressing member 310.

The pressing-rod driving part 330 includes a pressing-rod support 331 fixedly installed the upper end of the receiving container 200, and a rotating handle 333 connected to the upper end part of the pressing rod 320. The pressing-rod support 331 is fastened and fixed to the top of the support flange 240 by a fastening screw 340. The pressing-rod support 331 has a threaded hole 331a to which the pressing rod 320 is screwed. According to such configuration, when the rotating handle 333 of the upper part of the pressing rod 320 is rotated, the pressing rod 320 is guided by the threads of the threaded hole 331a while rotating so that the pressing rod 320 can move up and down. Accordingly, the pressing member 310 can be moved forcibly.

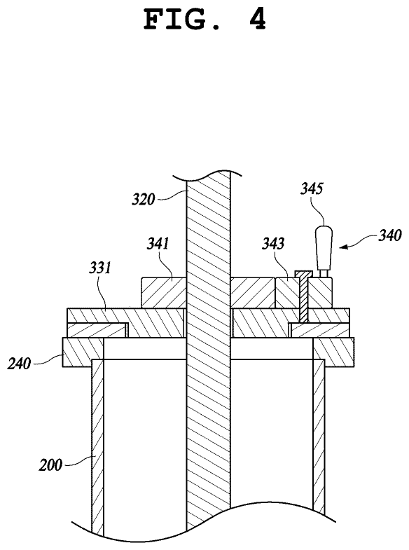

Meanwhile, referring to FIG. 4, a pressing-rod driving part 340 according to another embodiment includes a driven gear 341 coupled to the pressing rod 320, a drive gear 343 geared to the driven gear 341, and a gear drive part 345 for rotating the drive gear 343. The drive gear 343 is rotatably installed on the support flange 240. The gear drive part 345 may have an operating handle installed eccentrically to the drive gear 343. Accordingly, when the operating handle 345 is rotated, the drive gear 343 interlocks with the driven gear 341 to rotate the driven gear 341 while rotating. Then, the pressing rod 320 screwed to the center of the driven gear 341 may move downward or upward while rotating.

In addition, although not shown, as an example of the gear drive part 345, a bi-directional drive motor may be applied and installed. In this case, the drive gear 343 may be forcibly rotated so that the pressing rod 320 can move more easily.

As described above, according to the food dough forming apparatus according to the embodiment of the present disclosure, in a state in which various food raw materials are kneaded and put into the receiving container 200, the food dough is pressed and pushed into the forming hole 421 of the forming frame member 420 manufactured in advance so that the formed dough 20 can be formed into desired mass, size, and shape. That is, in a state in which the forming hole 421 is positioned to face the discharge hole 220 of the receiving container 200, when the pressing part 300 operates to press the food dough 10, a predetermined amount of the food dough 10 is pressed and filled into the forming hole 421. In this state, when the forming frame member 420 is moved by using the forming frame moving member 430, the food dough 10 filled in the forming hole 421 is separated from the food dough 10 in the discharge hole 220, and the formed dough 20 is formed in the shape of the forming hole 421. Then, the formed dough 20 in the forming hole 421 is separated from the forming hole 421 by using the separating part 500, and accordingly, the formed dough 20 can be easily and repeatedly made into the same shape.

For example, in a case in which the forming hole 421 is formed to have a circular shape, when a raw material of the food dough 10 is applied as a raw material for a hamburger patty, patties for a hamburger which are required to have constant mass, size, and shape can be made in large quantities in a short period by using the forming frame member 420.

Those skilled in the art to which the present disclosure pertains will understand that the present disclosure may be embodied in other specific forms without changing its technical spirit or essential features. Therefore, the embodiments described above should be understood as illustrative in all respects and not limiting. The scope of the present disclosure is indicated by the claims to be described later rather than the detailed description, and all changes or modifications derived from the meaning and scope of the claims and their equivalent concepts should be construed as being included in the scope of the present disclosure.

1. A food dough forming apparatus comprising:
a base;
a receiving container installed above the base and configured to receive food dough, the receiving container having a discharge hole at a lower part thereof;
a pressing part configured to press the food dough received in the receiving container downward;
a forming part installed movably under the receiving container, the forming part having a forming frame configured to form the food dough discharged through the discharge hole by being pressed by the pressing part inside the receiving container into a preset shape; and
a separating part configured to separate the formed dough formed in the forming part from the forming part.

2. The food dough forming apparatus of claim 1, wherein the forming part comprises:
a blocking wall installed by being spaced apart from the discharge hole of the receiving container so that the blocking wall faces the discharge hole; and
a forming frame member installed between the blocking wall and the discharge hole of the receiving container so that the forming frame member is capable of reciprocating, the forming frame member having a forming hole formed vertically therethrough so that the formed dough is formed in the forming hole.

3. The food dough forming apparatus of claim 2, wherein the forming hole comprises one pair of forming holes formed by being spaced apart from each other.

4. The food dough forming apparatus of claim 2, wherein the separating part comprises:
a support plate fixedly installed on the blocking wall such that the support plate is spaced apart from the forming frame member by facing the forming frame member; and
a pushing member installed on the support plate such that the pushing member is capable of moving up and down, the pushing member being configured to push the formed dough filled in the forming hole of the forming frame member out of the discharge hole of the receiving container during descent of the pushing member.

5. The food dough forming apparatus of claim 2, further comprising:
a forming frame moving member configured to horizontally reciprocate the forming frame member by an external force.

6. The food dough forming apparatus of claim 1, wherein the pressing part comprises:
a pressing member which is in close contact with an inner surface of the receiving container and pushes the food dough toward the discharge hole while moving;
a pressing rod connected to the pressing member and supported to be movable in an introduction hole of the receiving container; and
a pressing-rod driving part configured to reciprocate the pressing rod.
